(19) United States
(12) Patent Application Publication
(10) Pub. No.: US 2026/0226207 A1
(43) Pub. Date: Aug. 6, 2026

(54) METHOD FOR PREPARING MONOMODAL POLYISOPRENE WITH DILITHIUM INITIATORS

(71) Applicant: BRIDGESTONE CORPORATION, Chuo-ku, Tokyo (JP)

(72) Inventors: Walter A. SALAMANT, Akron, OH (US); Vrushali BHAGAT, Cuyahoga Falls, OH (US); Steven M. BALDWIN, Akron, OH (US); Ryan J. HUE, Akron, OH (US)

(73) Assignee: BRIDGESTONE CORPORATION, Chuo-ku, Tokyo (JP)

(21) Appl. No.: 19/151,157

(22) PCT Filed: Feb. 12, 2024
(86) PCT No.: PCT/US2024/015309

§ 371 Date: Jul. 25, 2025

Related U.S. Application Data
(60) Provisional application No. 63/484,349, filed on Feb. 10, 2023.

(51) Int. Cl. C08F 8/42; B60C 1/00; C08K 3/36

(52) U.S. Cl. CPC C08F 8/42; B60C 1/0016; C08K 3/36; C08F 2810/40

(57) ABSTRACT

A method for polymerizing isoprene, the method comprising (i) providing a dilithium initiator; (ii) introducing the dilithium initiator to isoprene monomer to form a polymerization mixture; and (iii) allowing the isoprene monomer to polymerize and form polyisoprene, where the polyisoprene is characterized by a monomodal molecular weight distribution.

### FIELD OF THE INVENTION

Embodiments of the present invention provide methods for preparing polyisoprene with a monomodal molecular weight distribution from dilithium initiators, as well as telechelic polyisoprene prepared using the methods of the invention.

### BACKGROUND OF THE INVENTION

Polydienes, such as poly(butadiene) and diene copolymers such as poly(styrene-co-butadiene), are often made by employing anionic polymerization techniques whereby diene monomer, optionally together with copolymerizable monomer such as vinyl aromatics, are polymerized using an anionic initiator. The use of anionic polymerization techniques leads to several advantages including the ability to control molecular weight, prepare relatively linear polymer chains, and functionalize the polymer chain through a chain termination reaction. Useful anionic initiators may include, for example, alkyl lithium compounds such as n-butyl lithium. Multi-functional initiators can be formed by reacting, for example, an alkyl lithium compound with a dialkenyl compound such as diisopropenylbenzene. Polymers prepared by using multi-functional initiators have multiple reactive chain ends, which provides the ability to functionalize both ends of a polymer chain to form a telechelic polymer.

### SUMMARY OF THE INVENTION

One or more embodiments of the present invention provide a method for polymerizing isoprene, the method comprising (i) providing a dilithium initiator; (ii) introducing the dilithium initiator to isoprene monomer to form a polymerization mixture; and (iii) allowing the isoprene monomer to polymerize and form polyisoprene, where the polyisoprene is characterized by a monomodal molecular weight distribution.

Other embodiments of the present invention provide a polyisoprene polymer prepared by providing a dilithium initiator, introducing the dilithium initiator to isoprene monomer to form a polymerization mixture, and allowing the isoprene monomer to polymerize and form polyisoprene, where the polyisoprene is characterized by a monomodal molecular weight distribution.

Yet other embodiments of the present invention provide a vulcanizable composition of matter including a monomodal polyisoprene polymer.

Still other embodiments of the present invention provide a vulcanizate prepared by vulcanizing a vulcanizable composition including a monomodal polyisoprene polymer.

Other embodiments of the present invention provide a tire prepared from a vulcanizable composition including a monomodal polyisoprene polymer.

### BRIEF DESCRIPTION OF THE DRAWINGS

FIG. 1 is a GPC trace of a multimodal polyisoprene polymer of Sample 1, which was prepared without employing the techniques of the present invention.

FIG. 2 is a GPC trace of a monomodal polyisoprene polymer of Sample 2, which was prepared by employing embodiments of the present invention.

FIG. 3A is a GPC trace of a monomodal polyisoprene polymer of Sample 3, which was prepared without employing techniques of the present invention.

FIG. 3B is a GPC trace of a monomodal polyisoprene polymer of Sample 4, which was prepared without employing techniques of the present invention.

FIG. 3C is a GPC trace of a multimodal polyisoprene polymer of Sample 5, which was prepared without employing techniques of the present invention.

FIG. 3D is a GPC trace of a monomodal polyisoprene polymer of Sample 6, which was prepared by employing embodiments of the present invention.

FIG. 4 is a GPC trace of a monomodal polyisoprene polymer of Sample 11, which was prepared by employing embodiments of the present invention.

### DETAILED DESCRIPTION OF ILLUSTRATIVE EMBODIMENTS

Embodiments of the invention are based, at least in part, on the discovery of a method for preparing monomodal polyisoprene using a dilithium initiator. According to embodiments of the invention, the dilithium initiator is prepared by reacting an alkyl lithium compound with a dialkenyl compound, and then allowing the initiator to age. The aged initiator is then introduced to the isoprene monomer to be polymerized. It has been discovered that while dilithium initiators have been used to prepare polydienes, such as polybutadiene and poly(styrene-co-butadiene), polymerization of isoprene with these dilithium initiators leads to multimodal polymer compositions. Embodiments of the present invention solve this problem. In one or more embodiments, monomodal polymer is obtained by polymerizing isoprene with a dilithium initiator in the presence of threshold amount of Lewis base. In other embodiments, monomodal polymer is obtained by first polymerizing polybutadiene oligomer, and then subsequently polymerizing isoprene monomer. Inasmuch as the monomodal polyisoprenes are prepared by anionic polymerization techniques, the use of a dilithium initiator advantageously leads to multiple polymer live ends (i.e. reactive ends), which allows for preparing telechelic diene copolymers. These telechelic diene polymers are advantageously used in the manufacture of tire components.

### Initiator Preparation and Aging

As indicated above, the dilithium initiator is prepared by combining a dialkenyl compound with an alkyl lithium compound within a solvent that forms a reaction mixture in which the reactants and product are at least partially soluble. The initiator is then aged in an appropriate solvent in the presence of a Lewis base.

In one or more embodiments, the dialkenyl compound is a 1,3-dialkenylbenzene compound such as 1,3-diisopropenylbenzene. In one or more embodiments, the alkyl lithium compound is a butyl lithium compound such as n-butyl lithium, t-butyl lithium, and/or sec-butyl lithium. In particular embodiments, sec-butyl lithium is employed.

The amount of alkyl lithium compound reacted with the dialkenyl compound may be quantified based upon the molar ratio of lithium to alkenyl groups; that is, equivalents of lithium associated with the alkyl lithium compound (i.e. mole of Li) relative to the equivalents of alkenyl groups within the dialkenyl compound (e.g. equivalents of isopropenyl groups within 1,3-diisopropenylbenzene. In one or more embodiments, the molar ratio of moles of Li associated with the alkyl lithium to equivalents of alkenyl groups associated with the dialkenyl compound may be from about 1.95:1 to about 2.05:1, in other embodiments from about 1.97:1 to about 2.03:1, and in other embodiments from about 1.99:1 to about 2.01:1. Where sec-butyl lithium is reacted with 1,3-diisopropenylbenzene, 2.00 moles of sec-butyl lithium may be reacted with each mole of 1,3-diisopropenylbenzene.

The Lewis base may include any Lewis base that does not include an active hydrogen atom, where the presence of an active hydrogen atom is determined by the Zerewitinoff test. Exemplary Lewis bases include oxolanyl propanes such as 2,2-bis(2-oxolanyl) propane (also known as 2,2-ditetrahydrofurylpropane), meso-2,2-diterahydrofurylpropane, DL-2,2,-ditetrahydrofurlypropane, and mixtures thereof, as well as trialkylamines such as triethylamine or N,N,N′,N′-tetramethylethylenediamine (TMEDA). In particular embodiments, triethylamine is employed. In other embodiments, mixtures of two or more different Lewis bases are employed.

The amount of Lewis base introduced to the reaction mixture may be quantified based upon the moles of Lewis base (e.g. 2,2-ditetrahydrofurylpropane) relative to the moles of lithium associated with the alkyl lithium compound (i.e. molar ratio of moles Lewis base to moles of lithium). In one or more embodiments, the molar ratio of moles of Lewis base introduced to the reaction medium to moles of lithium introduced with the alkyl lithium compound is from about 0.05:1 to about 2:1, in other embodiments from about 0.1:1 to about 1.5:1, and in other embodiments from about 0.5:1 to about 1:1.

The synthesis of the initiator takes place within a solvent in which the reactants and the product are at least partially soluble. Useful solvents include, but are not limited to, hydrocarbons with a low or relatively low boiling point such as aromatic hydrocarbons, aliphatic hydrocarbons, and cycloaliphatic hydrocarbons. Non-limiting examples of aromatic hydrocarbons include benzene, toluene, xylenes, ethylbenzene, diethylbenzene, and mesitylene. Non-limiting examples of aliphatic hydrocarbons include n-pentane, n-hexane, n-heptane, n-octane, n-nonane, n-decane, isopentane, isohexanes, isopentanes, isooctanes, 2,2-dimethylbutane, petroleum ether, kerosene, and petroleum spirits. And, non-limiting examples of cycloaliphatic hydrocarbons include cyclopentane, cyclohexane, methylcyclopentane, and methylcyclohexane. Mixtures of the above hydrocarbons may also be used.

As indicated above, the dilithium initiator formed by the foregoing reaction is aged within an appropriate solvent (e.g. within the reaction medium) in the presence of a Lewis base. In one or more embodiments, the Lewis base is present at the introduction of the reactants to the reaction mixture. In other embodiments, the Lewis base is introduced after synthesis of the dilithium initiator, and aging takes place after introduction of the Lewis base.

In one or more embodiments, aging of the initiator takes place under an inert atmosphere at atmospheric conditions at a temperature of from about 0 to about 150° C., in other embodiments from about 25 to about 100° C., and in other embodiments from about 35 to about 60° C. In one or more embodiments, the initiator is aged for greater than 15 minutes, in other embodiments greater than 20 minutes, in other embodiments greater than 25 minutes, and in other embodiments greater than 30 minutes before introducing the initiator to the monomer to be polymerized. In one or more embodiments, the initiator is aged for from about 15 minutes to about 4 hours, in other embodiments from about 20 minutes to about 3 hours, and in other embodiments from about 30 minutes to about 2 hours before introducing the initiator to the monomer to be polymerized.

### Polymerization Reaction

The dilithium initiator as prepared above and aged, is combined with the isoprene to be polymerized within an appropriate solvent to form a polymerization mixture in which the monomer and resulting polymer are at least partially soluble. In one or more embodiments, the initiator is also at least partially soluble within the polymerization mixture.

Generally speaking, the polymerization of isoprene monomer by the initiator proceeds by anionic polymerization techniques. The preparation of polymer by employing anionic polymerization techniques is generally known. The key mechanistic features of anionic polymerization have been described in books (e.g., Hsieh, H. L.; Quirk, R. P. Anionic Polymerization: Principles and Practical Applications; Marcel Dekker: New York, 1996) and review articles (e.g., Hadjichristidis, N.; Pitsikalis, M.; Pispas, S.; latrou, H.; Chem. Rev. 2001, 101 (12), 3747-3792). Anionic initiators may advantageously produce polymer having reactive chain ends (e.g., living polymers) that, prior to quenching, are capable of reacting with additional monomers for further chain growth or reacting with certain functionalizing agents to give functionalized polymers. The polymers having reactive polymer chain ends may simply be referred to as reactive polymers. As those skilled in the art appreciate, these reactive polymers include a reactive chain end, which is believed to be ionic, at which a reaction between a functionalizing agent and the reactive chain end of the polymer can take place, which thereby imparts a functionality or functional group to the polymer chain end, or which may couple multiple polymers together.

The polymerization mixture can be formed by introducing the various constituents in any order. For example, in one or more embodiments, the isoprene monomer, and solvent can first be combined, and then the aged initiator can be introduced to the mixture.

The amount of the initiator to be employed may depend on the interplay of various factors such as the type of initiator employed, the purity of the ingredients, the polymerization temperature, the polymerization rate and conversion desired, the molecular weight desired, and many other factors. In one or more embodiments, the amount of initiator employed may be expressed as the mmols of initiator per weight of monomer. In one or more embodiments, the amount of initiator introduced to the polymerization mixture is from about 0.1 to about 100 mmol, or in other embodiments from about 0.2 to about 50 mmol, or in other embodiments from about 0.3 to about 15 mmol of the initiator per 100 gram of monomer within the polymerization mixture (i.e. monomer to be polymerized).

### Solvent for Polymerization Mixture

In one or more embodiments, suitable solvents include those organic compounds that will not undergo polymerization or incorporation into propagating polymer chains during the polymerization of monomer in the presence of catalyst. In one or more embodiments, these organic species are liquid at ambient temperature and pressure. In one or more embodiments, these organic solvents are inert to the catalyst. Exemplary organic solvents include hydrocarbons with a low or relatively low boiling point such as aromatic hydrocarbons, aliphatic hydrocarbons, and cycloaliphatic hydrocarbons. Non-limiting examples of aromatic hydrocarbons include benzene, toluene, xylenes, ethylbenzene, diethylbenzene, and mesitylene. Non-limiting examples of aliphatic hydrocarbons include n-pentane, n-hexane, n-heptane, n-octane, n-nonane, n-decane, isopentane, isohexanes, isopentanes, isooctanes, 2,2-dimethylbutane, petroleum ether, kerosene, and petroleum spirits. And, non-limiting examples of cycloaliphatic hydrocarbons include cyclopentane, cyclohexane, methylcyclopentane, and methylcyclohexane. Mixtures of the above hydrocarbons may also be used. The low-boiling hydrocarbon solvents are typically separated from the polymer upon completion of the polymerization. Other examples of organic solvents include high-boiling hydrocarbons of high molecular weights, such as paraffinic oil, aromatic oil, or other hydrocarbon oils that are commonly used to oil-extend polymers. Since these hydrocarbons are non-volatile, they typically do not require separation and remain incorporated in the polymer.

### Modifier

The polymerization reaction may be conducted in the presence of a modifier, which may also be referred to as a polar coordinator or a vinyl modifier. As those skilled in the art appreciate, these compounds may serve multiple purposes within the polymerization. For example, they can assist in randomizing comonomer throughout the polymer chain; they can also modify the vinyl content of the mer units deriving from dienes. Compounds useful as randomizers include those having an oxygen or nitrogen heteroatom and a non-bonded pair of electrons (i.e. Lewis bases). Examples include linear and cyclic oligomeric oxolanyl alkanes; dialkyl ethers of mono and oligo alkylene glycols (also known as glyme ethers); “crown” ethers; tertiary amines; linear THF oligomers; and the like. Linear and cyclic oligomeric oxolanyl alkanes are described in U.S. Pat. Nos. 4,429,091 and 9,868,795, which are incorporated herein by reference. Specific examples of compounds useful as randomizers include 2,2-bis(2-oxolanyl) propane (also known as 2,2-ditetrahydrofurylpropane), meso-2,2-diterahydrofurylpropane, DL-2,2,-ditetrahdydrofurlypropane, and mixtures thereof, 1,2-dimethoxyethane, N,N,N′,N′-tetramethylethylenediamine (TMEDA), tetrahydrofuran (THF), 1,2-dipiperidylethane, dipiperidylmethane, hexamethylphosphoramide, N—N′-dimethylpiperazine, diazabicyclooctane, dimethyl ether, diethyl ether, tri-n-butylamine, and mixtures thereof. In other embodiments, potassium alkoxides can be used to randomize the styrene distribution. In one or more embodiments, a randomizer other than a potassium alkoxide is employed. In other embodiments, potassium alkoxide is the only randomizer present within the polymerization mixture.

The amount of randomizer to be employed may depend on various factors such as the desired microstructure of the polymer, the ratio of monomer to comonomer, the polymerization temperature, as well as the nature of the specific randomizer employed.

As noted above, embodiments of the invention provide for producing monomodal polyisoprene by polymerizing isoprene monomer in the presence of a threshold amount of a Lewis base. In particular embodiments, this Lewis base is selected from 2,2-bis(2-oxolanyl) propane (also known as 2,2-ditetrahydrofurylpropane), meso-2,2-diterahydrofurylpropane, DL-2,2,-ditetrahdydrofurlypropane, triethylamine, N,N,N′,N′-tetramethylethylenediamine (TMEDA) and mixtures thereof.

In one or more embodiments, the threshold amount of Lewis base present within the polymerization mixture that required to achieve a monomodal polyisoprene can include Lewis base introduced to the reaction mixture employed to make the initiator (i.e. it is carried forward from the initiator solution) or it can be added separately to the polymerization mixture (e.g. before, after or contemporaneously with the initiator or monomer). It will also be appreciated that this threshold amount may be achieved by one specific species of Lewis base (e.g. TMEDA) or from two or more Lewis bases. For example, the threshold amount can be achieved by adding a Lewis base (e.g. triethyl amine) to the reaction medium in preparing the initiator, and then additional Lewis base (e.g. 2,2-ditetrahydrofurylpropane) can be added directly to the polymerization mixture, and the combined amount (i.e. total amount) of the two Lewis bases achieve the threshold amount required to achieve a monomodal polyisoprene.

Within these embodiments, the total amount of Lewis base required to achieve a monomodal polyisoprene according to the invention can be quantified relative to the amount of lithium introduced to the polymerization system as part of the initiator. In one or more embodiments, the total amount of Lewis base (e.g. 2,2-ditetrahydrofurylpropane) present during initiator aging and subsequent polymerization is quantified as a molar ratio of the moles of Lewis base to the moles of lithium associated with the initiator. In one or more embodiments, the molar ratio of Lewis base to lithium is greater than 0.01:1, in other embodiments greater than 0.05:1, in other embodiments greater than 0.1:1, in other embodiments greater than 0.2:1, in other embodiments greater than 0.4:1, and in other embodiments greater than 0.5:1. In these or other embodiments, the molar ratio of Lewis base to lithium within the polymerization system is from about 0.05:1 to about 3:1, in other embodiments from about 0.1:1 about 3:1, in other embodiments from about 0.2:1 to about 2:1, in other embodiments from about 0.3:1 to about 1.5:1, in other embodiments from about 0.4:1 to about 1.5:1, and in other embodiments from about 0.5:1 to about 1.1:1.

### Polymerization Conditions and Techniques

The anionic initiator and other constituents of the polymerization system, such as the modifier, can be introduced to the polymerization system by various methods. In one or more embodiments, the anionic initiator and the modifier may be added separately to the monomer to be polymerized in either a stepwise or simultaneous manner.

As indicated above, polymerization of isoprene monomer in the presence of an effective amount of initiator produces a reactive polymer. The introduction of the initiator and monomer forms a polymerization mixture in which the reactive polymer is formed. Polymerization within a solvent produces a polymerization mixture in which the polymer product is dissolved or suspended in the solvent. This polymerization mixture may be referred to as a polymer cement.

In one or more embodiments, the polymerization may be conducted in any conventional polymerization vessel known in the art. For example, the polymerization can be conducted in a conventional stirred-tank reactor. In one or more embodiments, all of the ingredients used for the polymerization can be combined within a single vessel (e.g., a conventional stirred-tank reactor), and all steps of the polymerization process can be conducted within this vessel. In other embodiments, two or more of the ingredients can be pre-combined in one vessel and then transferred to another vessel where the polymerization of monomer (or at least a major portion thereof) may be conducted. Because various embodiments of the present invention include the use of multiple reactors or reaction zones, the vessel (e.g., tank reactor) in which the polymerization is conducted may be referred to as a first vessel or first reaction zone.

The polymerization can be carried out as a batch process, a continuous process, or a semi-continuous process. In the semi-continuous process, the monomer is intermittently charged as needed to replace that monomer already polymerized. In one or more embodiments, the heat of polymerization may be removed by external cooling by a thermally controlled reactor jacket, internal cooling by evaporation and condensation of the monomer through the use of a reflux condenser connected to the reactor, or a combination of the two methods. Also, conditions may be controlled to conduct the polymerization under a pressure of from about 0.1 atmospheres to 50 atmospheres, in other embodiments from about 0.5 atmosphere to about 20 atmospheres, and in other embodiments from about 1 atmosphere to about 10 atmospheres. In one or more embodiments, the pressures at which the polymerization may be carried out include those that ensure that the majority of the monomer is in the liquid phase. In these or other embodiments, the polymerization mixture may be maintained under anaerobic conditions.

In one or more embodiments, the conditions under which the polymerization proceeds may be controlled to maintain the peak polymerization temperature of the polymerization mixture at greater than 30° C., in other embodiments greater than 50° C., and in other embodiments greater than 70° C. In these or other embodiments, the conditions under which the polymerization proceeds may be controlled to maintain the peak polymerization temperature of the polymerization mixture at less than 120° C., in other embodiments less than 110° C., and in other embodiments less than 100° C. In one or more embodiments, the conditions under which the polymerization proceeds may be controlled to maintain the temperature of the polymerization mixture within a range from about −10° C. to about 200° C., in other embodiments from about 0° C. to about 150° C., and in other embodiments from about 20° C. to about 110° C.

### Butadiene Polymerization

As indicated above, embodiments of the invention include forming monomodal polyisoprene by first polymerizing 1,3-butadiene monomer to form a polybutadiene oligomer, and then subsequently polymerizing isoprene monomer. This process may also be referred to as butadiene seeding. As the skilled person will appreciate, this can be accomplished by first introducing 1,3-butadiene monomer (which may be referred to as butadiene monomer unless otherwise stated) and the initiator, which results in the formation of a polymerization mixture in which the butadiene is polymerized to thereby form a reactive macromolecule having two reactive butadiene chains extending from the initiator residue. Isoprene monomer is subsequently introduced to the polymerization mixture. Polymerization is continued by the isoprene monomer adding to the reactive ends of the butadiene chains to thereby form polyisoprene chains extending from the butadiene oligomer chains.

In one or more embodiments, the butadiene chains that are formed are relatively short chains (e.g. they may be referred to as butadiene oligomer chains) that are formed by introducing a limited amount of butadiene monomer. The amount of butadiene employed in the synthesis of this invention (i.e. within the seeding step) may be quantified based upon the equivalents of lithium associated with the initiator. In one or more embodiments, less than 100 moles, in other embodiments less than 75 moles, in other embodiments less than 50 moles, in other embodiments less than 30 moles, in other embodiments less than 15 moles, and in other embodiments less than 10 moles of 1,3-butadiene monomer per equivalent of lithium associated with the initiator is polymerized in the seeding step. In one or more embodiments, the amount of 1,3-butadiene monomer polymerized in the seeding step is from about 3 to about 100, in other embodiments from about 5 to about 50, and in other embodiments from about 10 to about to about 50 moles of 1,3-butadiene per equivalent of lithium associated with the initiator. Stated differently, the molar ratio of butadiene to the DiLi initiator is less than 200:1, in other embodiments less than 150:1, in other embodiments less than 50:1, in other embodiments less than 30:1, in other embodiments less than 15:1, and in other embodiments less than 10:1. In one or more embodiments, the molar ratio of butadiene to lithium atoms associated with the DiLi initiator is from about 3:1 to about 100:1, in other embodiments from about 5:1 to about 50:1, and in other embodiments from about 10:1 to about 50:1.

The process of butadiene seeding is particularly advantageous where there is a desire to produce monomodal polyisoprene. As the skilled person will appreciate, where monomodal polyisoprene is achieved by introducing a threshold amount of Lewis base to the polymerization mixture, the increased loading of Lewis base will not only produce a monomodal polyisoprene, but will also increase the vinyl content of the polymer produced. Thus, in one or more embodiments, the butadiene seeding, and the subsequent polymerization of isoprene, takes place in the presence of limited amounts of Lewis base. In one or more embodiments, the limited amount is less than that amount that would otherwise be required to produce a monomodal polyisoprene according to aspects of this invention. As with other embodiments, the limited amount of Lewis base present during butadiene seeding and the subsequent polymerization of isoprene can be quantified as a molar ratio of the moles of Lewis base to the moles of lithium associated with the initiator. In one or more embodiments, the molar ratio of Lewis base to lithium (within the polymerization mixture) is less than 0.1:1, in other embodiments less than 0.08:1, in other embodiments less than 0.5:1, and in other embodiments less than 0.3:1. In these or other embodiments, the molar ratio of Lewis base to lithium within the polymerization system is from about 0.01:1 to about 0.1:1, in other embodiments from about 0.02:1 about 0.08:1, and in other embodiments from about 0.03:1 to about 0.05:1.

### Pre-Functionalization Polymer Characteristics

Prior to functionalization, which is further described below, the reactive polymers prepared by the practice of this invention (i.e. polyisoprene) may be characterized by their molecular weight, which may include number average molecular weight (Mn), weight average molecular weight (Mw), and peak molecular weight (Mp). As those skilled in the art will appreciate, molecular weight can be determined, for example, by using gel permeation chromatography (GPC) together with an UV absorption, differential refractometer (DRI), refractive index (RI), infrared (IR) absorption detector, and by employing appropriate calibration standards and THE as a solvent. For purposes of this specification, GPC measurements employ polystyrene standards and polystyrene Mark Houwink constants unless otherwise specified. For purposes of this specification, prior to functionalization, the polymer may be referred to as the base polymer, and the pre-functionalized characteristics of the polymer may be referred to as the characteristics of the base polymer.

According to embodiments of the present invention, the pre-functionalized polymers have a single peak molecular weight (Mp). In one or more embodiments, the pre-functionalized polymers have an Mp, which may also be referred to as the base Mp, of greater than 160 kg/mol, in other embodiments greater than 170 kg/mol, and in other embodiments greater than 180 kg/mol. In these or other embodiments, the pre-functionalized polymers have a base Mp of less 280 kg/mol, in other embodiments less than 260 kg/mol, and in other embodiments less than 250 kg/mol. In one or more embodiments, the pre-functionalized polymers have a base Mp of from about 160 to about 280 kg/mol, in other embodiments from about 170 to about 260 kg/mol, and in other embodiments from about 180 to about 250 kg/mol.

In one or more embodiments, the pre-functionalized polymers have an Mn, which may also be referred to as the base Mn, of greater than 130 kg/mol, in other embodiments greater than 140 kg/mol, and in other embodiments greater than 150 kg/mol. In these or other embodiments, the pre-functionalized polymers have a base Mn of less 300 kg/mol, in other embodiments less than 280 kg/mol, and in other embodiments less than 260 kg/mol. In one or more embodiments, the pre-functionalized polymers have a base Mn of from about 130 to about 300 kg/mol, in other embodiments from about 140 to about 280 kg/mol, and in other embodiments from about 150 to about 260 kg/mol.

In one or more embodiments, the pre-functionalized polymers have an Mw, which may also be referred to as the base Mw, of greater than 180 kg/mol, in other embodiments greater than 190 kg/mol, and in other embodiments greater than 200 kg/mol. In these or other embodiments, the pre-functionalized polymers have a base Mw of less 500 kg/mol, in other embodiments less than 450 kg/mol, and in other embodiments less than 400 kg/mol. In one or more embodiments, the pre-functionalized polymers have a base Mw of from about 180 to about 500 kg/mol, in other embodiments from about 190 to about 450 kg/mol, and in other embodiments from about 200 to about 400 kg/mol.

In one or more embodiments, the base polymer may be characterized by a polydispersity, which may also be referred to as a molecular weight distribution (Mw/Mn) of less than of less than 3, in other embodiments less than 2.5, in other embodiments less than 2.0, and in other embodiments less than 1.8.

The pre-functionalized polymers produced according to aspects of the present invention may be characterized by vinyl content, which may be described as the number of unsaturations in the 3,4-microstructure, relative to the total unsaturations within the polymer chain. As the skilled person will appreciate, vinyl content can be determined by NMR analysis at 400 MHz using CDCl₃ as a solvent. In one or more embodiments, the pre-functionalized polymers include greater than 5%, in other embodiments greater than 8%, in other embodiments greater than 10%, in other embodiments greater than 20%, and in other embodiments greater than 35% vinyl. In these or other embodiments, the pre-functionalized polymers include less than 80%, in other embodiments less than 60%, and in other embodiments less than 46%. In one or more embodiments, the pre-functionalized polymers include from about 5% to about 80%, in other embodiments from about 8% to about 60%, and in other embodiments from about 20% to about 46% vinyl.

### Polymer Functionalization

The polymer produced by the polymerization of this invention (i.e. which proceeds by anionic polymerization techniques) includes reactive ends (i.e. the growing ends) that are capable of being modified, which may also be referred to as functionalized, to provide functionalized polymers having a functional group at both ends of a linear polymer, which may be referred to as a telechelic polymer. That is, the reactive ends of the polymer is modified, which may also be referred to as functionalized, by introducing a functionalizing agent to the polymerization mixture. It is believed that the polymer chain ends react with the functionalizing agent (which may also be referred to as a modifying agent) to provide a residue of the functionalizing agent at the end of the polymer chain. Accordingly, the reaction between the polymer and the functionalizing agent produces a polymer composition wherein both ends of a linear polymer include a terminal group deriving from the functionalizing agent. It should be appreciated that the reaction between the functionalizing agent and the reactive ends of the polymer can also result in polymer coupling of two or more polymer chains. In either event, the polymers bearing a chain-end functional group or polymers coupled with the residue of the functionalizing agent will both be referred to as modified or functionalized branched polymers unless otherwise designated.

### Functionalizing Agents

Useful functionalizing agents include those functionalizing agents conventionally employed in the art. In one or more embodiments, the functionalizing agent imparts a terminal functionality that can be reactive or interactive with other polymer chains (propagating and/or non-propagating) or with other materials in a rubber compound such as particulate reinforcing fillers (e.g. carbon black or silica). As described above, enhanced interactivity between a polymer and particulate fillers in rubber compounds improves the mechanical and dynamic properties of resulting vulcanizates. For example, certain functionalizing agents can impart a terminal functionality that includes one or more heteroatoms. In one or more embodiments, the functionalizing agent may produce a functionalized polymer that can be used in rubber compositions from which vulcanizates can be provided, and these vulcanizates can possess high temperature (e.g., 50° C.) hysteresis losses that are less than those possessed by vulcanizates prepared from similar rubber compounds that do not include the functionalized polymers. Reductions in high temperature hysteresis loss can be at least 5%, sometimes at least 10%, and occasionally at least 15%.

Exemplary types of compounds that can be used to end-functionalize the reactive branched polymers of this invention include imines, amines, hydrocarbyloxy silanes, amine-containing hydrocarbyloxy silanes, halogenated organics, trialkyl tin compounds, carbon dioxide, benzophenones, benzaldehydes, imidazolidones, pyrrolidinones, carbodiimides, ureas, isocyanates, and Schiff bases. It should also be appreciated that two or more different species of functionalizing agent can be employed in practicing the present invention.

### Hydrocarbyloxy Silane Functionalizing Agents

In one or more embodiments, hydrocarbyloxy silane functionalizing agents may be defined by the formula:

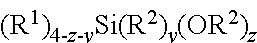

where R¹ is a halogen atom or a monovalent organic group, each R² is a monovalent organic group, z is an integer from 1 to 4, and y is an integer from 0 to 2. In one embodiment, the halogen atom is chlorine.

In one or more embodiments, the monovalent organic groups include hydrocarbyl groups such as, but not limited to, alkyl, cycloalkyl, alkenyl, cycloalkenyl, aryl, allyl, aralkyl, alkaryl, or alkynyl groups. Hydrocarbyl groups also include substituted hydrocarbyl groups, which refer to hydrocarbyl groups in which one or more hydrogen atoms have been replaced by a substituent such as a hydrocarbyl group. In one or more embodiments, these groups may include from one, or the appropriate minimum number of carbon atoms to form the group, to about 20 carbon atoms. These groups may or may not contain heteroatoms. Suitable heteroatoms include, but not limited to, nitrogen, boron, oxygen, silicon, sulfur, tin, and phosphorus atoms. In one or more embodiments, the cycloalkyl, cycloalkenyl, and aryl groups are non-heterocyclic groups. In these or other embodiments, the substituents forming substituted hydrocarbyl groups are non-heterocyclic groups.

Suitable examples of siloxane terminating agents include tetraalkoxysilanes, alkylalkoxysilanes, arylalkoxysilanes, alkenylalkoxysilanes, and haloalkoxysilanes.

Examples of tetraalkoxysilane compounds include tetramethyl orthosilicate, tetraethyl orthosilicate, tetrapropyl orthosilicate, tetrabutyl orthosilicate, tetra(2-ethylhexyl) orthosilicate, tetraphenyl orthosilicate, and tetratoluyloxysilane.

Examples of alkylalkoxysilane compounds include methyltrimethoxysilane, methyltriethoxysilane, methyltri-n-propoxysilane, methyltri-n-butoxysilane, methyltriphenoxysilane, ethyltrimethoxysilane, ethyltriethoxysilane, ethyltri-n-propoxysilane, ethyltri-n-butoxysilane, ethyltriphenoxysilane, dimethyldimethoxysilane, dimethyldiethoxysilane, dimethyldi-n-propoxysilane, dimethyldi-n-butoxysilane, dimethyldiphenoxysilane, diethyldimethoxysilane, and diphenyldimethoxysilane.

Examples of arylalkoxysilane compounds include phenyltrimethoxysilane, phenyltriethoxysilane, phenyltri-n-propoxysilane, phenyltri-n-butoxysilane, and phenyltriphenoxysilane.

Examples of alkenylalkoxysilane compounds include vinyltrimethoxysilane, vinyltriethoxysilane, vinyltri-n-propoxysilane, vinyltri-n-butoxysilane, vinyltriphenoxysilane, allyltrimethoxysilane, octenyltrimethoxysilane, and divinyldimethoxysilane.

Examples of haloalkoxysilane compounds include trimethoxychlorosilane, triethoxychlorosilane, tri-n-propoxychlorosilane, tri-n-butoxychlorosilane, triphenoxychlorosilane, dimethoxydichlorosilane, diethoxydichlorosilane, di-n-diphenoxydichlorosilane, methoxytrichlorosilane, propoxydichlorosilane, phenoxytrichlorosilane, ethoxytrichlorosilane, n-propoxytrichlorosilane, triethoxybromosilane, trimethoxybromosilane, tri-n-propoxybromosilane, dimethoxydibromosilane, diethoxydibromosilane, di-n-triphenoxybromosilane, diphenoxydibromosilane, methoxytribromosilane, propoxydibromosilane, ethoxytribromosilane, n-propoxytribromosilane, phenoxytribromosilane, trimethoxyiodosilane, triethoxyiodosilane, tri-n-propoxyiodosilane, triphenoxyiodosilane, dimethoxydiiodosilane, di-n-propoxydiiodosilane, diphenoxydiiodosilane, methoxytriiodosilane, ethoxytriiodosilane, n-propoxytriiodosilane, and phenoxytriiodosilane.

Techniques for preparing functionalized polymers by using hydrocarbyloxy silane compounds are set forth in U.S. Pat. Nos. 3,244,664; 6,008,295; 6,228,908; and 4,185,042, which are incorporated herein by reference.

In one or more embodiments, hydrocarbyloxy silane functionalizing agents is an imino-containing hydrocarbyloxy silane that may be defined by the formula:

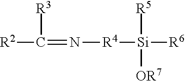

where R², R³, and R⁷ are monovalent organic groups, R⁴ is a divalent organic group, and where R⁵ and R⁶ are each independently hydrocarbyloxy groups or hydrocarbyl groups.

In one or more embodiments, the divalent organic group is a hydrocarbylene groups such as, but not limited to, alkylene, cycloalkylene, alkenylene, cycloalkenylene, alkynylene, cycloalkynylene, or arylene groups. Hydrocarbylene groups include substituted hydrocarbylene groups, which refer to hydrocarbylene groups in which one or more hydrogen atoms have been replaced by a substituent such as a hydrocarbyl group. In one or more embodiments, these groups may include from one, or the appropriate minimum number of carbon atoms to form the group, to about 20 carbon atoms. These groups may or may not contain heteroatoms. Suitable heteroatoms include, but not limited to, nitrogen, boron, oxygen, silicon, sulfur, tin, and phosphorus atoms. In one or more embodiments, the cycloalkylene, cycloalkenylene, and arylene groups are non-heterocyclic groups. In these or other embodiments, the substituents forming substituted hydrocarbylene groups are non-heterocyclic groups.

Examples of these imino-containing hydrocarbyloxy silane compounds include triethoxy compounds such as, but are not limited to, N-(1,3-dimethylbutylidene)-3-(triethoxysilyl)-1-propaneamine, N-(1-methylethylidene)-3-(triethoxysilyl)-1-propaneamine, N-ethylidene-3-(triethoxysilyl)-1-propaneamine, N-(1-methylpropylidene)-3-(triethoxysilyl)-1-propaneamine, N-(4-N,N-dimethylaminobenzylidene)-3-(triethoxysilyl)-1-propaneamine, and N-(cyclohexylidene)-3-(triethoxysilyl)-1-propaneamine. Other examples include trimethoxy compounds such as, but not limited to, N-(1,3-dimethylbutylidene)-3-(trimethoxysilyl)-1-propaneamine, N-(1-methylethylidene)-3-(trimethoxysilyl)-1-propaneamine, N-ethylidene-3-(trimethoxysilyl)-1-propaneamine, N-(1-methylpropylidene)-3-(trimethoxysilyl)-1-propaneamine, N-(4-N,N-dimethylaminobenzylidene)-3-(trimethoxysilyl)-1-propaneamine, and N-(cyclohexylidene)-3-(trimethoxysilyl)-1-propaneamine. Other examples include methyldiethoxy compounds such as, but not limited to, N-(1,3-dimethylbutylidene)-3-(methyldiethoxysilyl)-1-propaneamine, N-(1-methylethylidene)-3-(methyldiethoxysilyl)-1-propaneamine, N-ethylidene-3-(methyldiethoxysilyl)-1-propaneamine, N-(1-methylpropylidene)-3-(methyldiethoxysilyl)-1-propaneamine, N-(4-N,N-dimethylaminobenzylidene)-3-(methyldiethoxysilyl)-1-propaneamine, and N-include (cyclohexylidene)-3-(methyldiethoxysilyl)-1-propaneamine. Other examples ethyldimethoxy compounds such as, but not limited to, N-(1,3-dimethylbutylidene)-3-(ethyldimethoxysilyl)-1-propaneamine, N-(1-methylethylidene)-3-(ethyldimethoxysilyl)-1-propaneamine, N-ethylidene-3-(ethyldimethoxysilyl)-1-propaneamine, N-(1-methylpropylidene)-3-(ethyldimethoxysilyl)-1-propaneamine, N-(4-N,N-dimethylaminobenzylidene)-3-(ethyldimethoxysilyl)-1-propaneamine, and N-(cyclohexylidene)-3-(ethyldimethoxysilyl)-1-propaneamine.

Techniques for preparing functionalized polymers by using imine-containing hydrocarbyloxy compounds are disclosed in U.S. Publication Nos. 2005/0009979; 2010/0113683; and 2011/0092633, which are incorporated herein by reference.

In one or more embodiments, hydrocarbyloxy silane functionalizing agents is a hydrocarbyloxy silane defined by the formula:

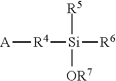

where R⁴ is a divalent organic group, where R⁵ and R⁶ are each independently hydrocarbyloxy groups or hydrocarbyl groups, R⁵ is a monovalent organic group, and A is selected from the group consisting of carboxylic ester, cyclic tertiary amine, non-cyclic tertiary amine, pyridine, silazane, epoxy, isocyanate, cyano, carboxylic anhydride and sulfide groups.

Examples of hydrocarbyloxy silane compounds including a carboxylic ester group include, but are not limited to, 3-methacryloyloxypropyltriethoxysilane, 3-methacryloyloxypropyltrimethoxysilane, 3-methacryloyloxypropylmethyldiethoxysilane, and 3-methacryloyloxypropyltriisopropoxysilane.

Examples of hydrocarbyloxy silane compounds including a cyclic tertiary amine group include, but are not limited to, 3-(1-hexamethyleneimino) propyltriethoxysilane, 3-(1-hexamethyleneimino) propyltrimethoxysilane, (1-hexamethyleneimino)methyltriethoxysilane, (1-hexamethyleneimino)methyltrimethoxysilane, 2-(1-hexamethyleneimino)ethyltriethoxysilane, 3-(1-hexamethyleneimino)ethyltrimethoxysilane, 3-(1-pyrrolidinyl) propyltrimethoxysilane, 3-(1-pyrrolidinyl) propyltriethoxysilane, 3-(1-heptamethyleneimino) propyltriethoxysilane, 3-(1-dodecamethyleneimino) propyltriethoxysilane, 3-(1-hexamethyleneimino) propyldiethoxyethylsilane, and 3-[10-(triethoxysilyl)decyl]-4-oxazoline.

Examples of hydrocarbyloxy silane compounds including a non-cyclic tertiary amine group include, but are not limited to, 3-dimethylaminopropyltriethoxysilane, 3-dimethylaminopropyltrimethoxysilane, 3-diethylaminopropyltrimethoxysilane, 3-diethylaminopropyltriethoxysilane, 2-dimethylaminoethyltriethoxysilane, 2-dimethylaminoethyltrimethoxysilane, 3-dimethylaminopropyldiethoxymethylsilane, 3-diethylaminopropyldiethoxymethylsilane, 3-dimethylaminopropyldimethoxymethylsilane, 3-diethylaminopropyldimethoxymethylsilane, and 3-dibutylaminopropyltriethoxysilane.

Examples of hydrocarbyloxy silane compounds including a pyridine group include, but are not limited to, 2-trimethoxysilylethylpyridine.

Examples of hydrocarbyloxy silane compounds including a silazane group include, but are not limited to, N,N-bis(trimethylsilyl)-aminopropylmethyldimethoxysilane, 1-trimethylsilyl-2,2-dimethoxy-1-aza-2-silacyclopentane, N,N-bis(trimethylsilyl) aminopropyltrimethoxysilane, N,N-bis(trimethylsilyl)aminopropyltriethoxysilane, N,N-bis(trimethylsilyl)aminopropylmethyldiethoxysilane, N,N-bis(trimethylsilyl)aminoethyltrimethoxysilane, N,N-bis(trimethylsilyl)aminoethyltriethoxysilane, N,N-bis(trimethylsilyl)aminoethylmethyldimethoxysilane, and N,N-bis(trimethylsilyl)aminoethylmethyldiethoxysilane.

Examples of hydrocarbyloxy silane compounds including an isocyanate group include, but are not limited to, 3-isocyanatopropyltrimethoxysilane, 3-isocyanatopropyltriethoxysilane, 3-isocyanatopropylmethyldiethoxysilane, and 3-isocyanatopropyltriisopropoxysilane.

Examples of hydrocarbyloxy silane compounds including a cyano group include, but are not limited to, are 2-cyanoethyltriethoxysilane, 2-cyanoethyldiethoxymethylsilane, 3-cyanopropyltriethoxysilane, 2-cyanoethylpropyltriethoxysilane and 3-cyanopropyldiethoxymethylsilane.

Examples of hydrocarbyloxy silane compounds including a carboxylic anhydride group include, but are not limited to, 3-trimethoxysilylpropylsuccinic anhydride, 3-triethoxysilylpropylsuccinic anhydride, and 3-methyldiethoxysilylpropylsuccinic anhydride.

Examples of hydrocarbyloxy silane compounds including an epoxy group, include, but are not limited to, 2-glycidoxyethyltrimethoxysilane, 2-glycidoxyethyltriethoxysilane, (2-glycidoxyethyl)methyldimethoxysilane, 3-glycidoxypropyltrimethoxysilane, 3-glycidoxypropyltriethoxysilane, (3-glycidoxypropyl)-methyldimethoxysilane, 2-(3,4-epoxycyclohexyl)ethyltrimethoxysilane, 2-(3,4-epoxycyclohexyl)ethyltriethoxysilane, and 2-(3,4-epoxycyclohexyl)ethyl(methyl)dimethoxysilane.

Still other specific examples of useful functionalizing agents include trialkyltin halides such as triisobutyltin chloride, as disclosed in U.S. Pat. Nos. 4,519,431; 4,540,744; 4,603,722; 5,248,722; 5,349,024; 5,502,129; and 5,877,336, which are incorporated herein by reference. Examples of useful halogenated organic compounds include cyclic amino compounds such as hexamethyleneimine alkyl chloride, as disclosed in U.S. Pat. Nos. 5,786,441; 5,916,976; and 5,552,473, which are incorporated herein by reference. Additional examples include cyclic sulfur-containing or oxygen containing azaheterocycles such as disclosed in WO 2004/020475; U.S. Publication No. 2006/0178467; and U.S. Pat. No. 6,596,798, which are incorporated herein by reference. Other examples include boron-containing terminators such as disclosed in U.S. Pat. No. 7,598,322, which is incorporated herein by reference. Still other examples include cyclic siloxanes such as hexamethylcyclotrisiloxane, including those disclosed in U.S. Pat. No. 9,920,149, which is incorporated herein by reference. Yet other examples include polydimethylsiloxanes.

### Amount of Functionalization Agent Used

The amount of functionalizing employed in the practice of the present invention can be described with respect to the lithium or metal cation associated with the initiator. In one or more embodiments, the amount of functionalizing agent introduced to the polymerization mixture is greater than 0.70, in other embodiments greater than 0.75, in other embodiments greater than 0.80, in other embodiments greater than 0.85, and in other embodiments greater than 0.90 moles of functionalizing agent per mole of lithium in the initiator. In these or other embodiments, less than 0.99, in other embodiments less than 0.97, and in other embodiments less than 0.95 moles of functionalizing agent per mole of lithium is introduced to the polymerization mixture. In one or more embodiments, from about 0.7 to about 1.0, in other embodiments from about 0.75 to about 0.99, and in other embodiments from about 0.80 to about 0.97 moles of functionalizing agent per mole of lithium is introduced to the polymerization mixture.

### Functionalization Reaction

The reaction between the respective species of functionalizing agents and the polymer can take place by introduction the functionalizing agent sequentially or simultaneously to the reactive polymer.

In one or more embodiments, the reaction between the functionalizing agent and the reactive polymer may take place at a temperature from about 10° C. to about 150° C., and in other embodiments from about 20° C. to about 100° C. The time required for completing the reaction between the functionalizing agent and the reactive polymer depends on various factors such as the type and amount of the initiator used to prepare the reactive polymer, the type and amount of the functionalizing agent, as well as the temperature at which the functionalization reaction is conducted. In one or more embodiments, the reaction between the functionalizing agent and the reactive polymer can be conducted for about 10 to 60 minutes.

In one or more embodiments, the functionalizing agent is introduced to the polymer cement (i.e. polymerization mixture) while the polymer is dissolved or suspended within a solvent. As those skilled in the art appreciate, this solution may be referred to as a polymer cement, or more specifically as a reactive or living polymer cement. In one or more embodiments, the characteristics of the polymer cement, such as its concentration, will be the same or similar to the characteristics of the cement prior to functionalization. The composition including the functionalized polymer and solvent may be referred to as a polymerization mixture; in other words, a polymerization mixture including a functionalized polymer.

In one or more embodiments, modification of the polymer (i.e., introduction of the functionalizing agent to the polymer cement), takes place within the same vessel in which the polymerization was conducted. In other embodiments, modification of the polymer takes place outside of the reaction vessel in which the polymerization takes place. For example, the first and second functionalizing agents can be introduced to the polymerization mixture (i.e. polymer cement) in a downstream vessel or a downstream transfer conduit.

According to one or more embodiments, as a result of the functionalization reaction, greater than 60 mol %, in other embodiments greater than 70 mol %, in other embodiments greater than 80 mol %, in other embodiments greater than 85 mol %, in other embodiments greater than 90 mol %, and in other embodiments greater than 95 mol % of the polymer chains within the polymer cement include a terminal functional group (i.e. the residue of a functionalizing agent). In one or more embodiments, from about 60 to about 100 mol %, in other embodiments from about 70 to about 99 mol %, in other embodiments from about 80 to about 98 mol %, and in other embodiments from about 90 to about 97 mol % of the polymer chains within the polymer composition include the terminal functional group.

### Polymer Stabilization

In one or more embodiments, following modification, the modified polymer (i.e. the telechelic polymer) may optionally be stabilized (i.e. post-functionalization stabilized). That is, the modified polymer may be stabilized by introducing a stabilizing agent to the polymerization mixture including the modified polymer. It is believed that the stabilizing agent reacts with certain terminal functional groups (e.g. a hydrocarbyloxy substituent), and it is believed that this reaction may take place at the introduction of the two molecules or after aging of the composition.

In one or more embodiments, stabilizing agents known in the art may be used. For example, the stabilizing agents may include alkylalkoxy silanes as disclosed in U.S. Pat. No. 6,255,404, which is incorporated herein by reference. Exemplary alkylalkoxy silanes include octyltriethoxy silane. In other embodiments, the stabilizing agent may include long-chain alcohols as disclosed in U.S. Pat. No. 6,279,632, which is incorporated herein by reference. Exemplary long chain alcohols include sorbitan stearate or sorbitan monooleate. In still other embodiments, the polymers may be stabilized by treatment with an alkylalkoxy silane followed by treatment with a silane including a hydrolyzable group that forms an acidic species upon hydrolysis, such as methyltrichlorosilane, as disclosed in U.S. Pat. No. 9,546,237, which is incorporated herein by reference.

In one or more embodiments of this invention, aryl silanols (also known as hydroxy phenyl silanes) are advantageously used as a stabilizing agent. Useful aryl silanols are disclosed in U.S. Pat. No. 9,255,167, which is incorporated herein by reference. Exemplary aryl silanols include, but are not limited to, triphenylsilanol, which is also referred to as hydroxytriphenylsilane, diphenylsilanediol, which is also referred to as dihydroxydiphenylsilane, and phenylsilanetriol, which is also referred to as trihydroxy (phenyl) silane.

In one or more embodiments, the functionalized polymers of this invention may be stabilized by treatment with an aryl silanol (e.g. aryl silane diol or aryl silane triol) contemporaneously or followed by treatment with a silane including a hydrolyzable group that forms an acidic species upon hydrolysis. Silanes including a hydrolyzable group that form an acidic species upon hydrolysis are disclosed in U.S. Pat. No. 9,546,237, which is incorporated herein by reference. In particular embodiments, the functionalized polymers are treated with diphenyl silane diol and trimethyl silyl chloride.

In one or more embodiments, the stabilizing agent is added to the polymer cement after a sufficient time is provided to allow completion of the reaction between the reactive polymer and the functionalizing agent. In one or more embodiments, the stabilizing agent is introduced to the polymer cement after 30 minutes, in other embodiments after 15 minutes, and in other embodiments after 10 minutes from the time that the functionalizing agent is introduced to the polymer cement.

The amount of stabilizing agent (i.e. aryl silanol) employed in the practice of the present invention can be described with respect to the moles of lithium associated with the initiator. In one or more embodiments, greater than 0.5, in other embodiments greater than 1, in other embodiments greater than 2, and in other embodiments greater than 3 moles of stabilizing agent per mole of lithium in the initiator is introduced to the polymerization mixture. In these or other embodiments, less than 8, in other embodiments less than 7, in other embodiments less than 6, in other embodiments less than 5, and in other embodiments less than 4.5 moles of stabilizing agent per mole of lithium is introduced to the polymerization mixture. In one or more embodiments, from about 1 to about 7, in other embodiments from about 2 to about 6, and in other embodiments from about 3 to about 5 moles of stabilizing agent per mole of lithium is introduced to the polymerization mixture.

In other embodiments, the amount of stabilizing agent (i.e. aryl silanol) employed in the practice of the present invention can be described as a molar ratio relative to the moles of functionalizing agent employed. In one or more embodiments, the ratio of the moles of stabilizing agent to the moles of functionalizing agent employed is from about 0.5:1 to about 8:1; in other embodiments from about 1:1 to about 7:1, in other embodiment from about 2:1 to about 6:1, and in other embodiments from about 3:1 to about 5:1. In these or other embodiments, the ratio of the moles of stabilizing agent to the moles of functionalizing agent employed is less than 7:1, in other embodiments less than 6:1, in other embodiments less than 5.5:1, in other embodiments less than 5:1, and in other embodiments less than 4.5:1.

Where two reagents are employed, such as where the polymer is treated with an aryl silanol (e.g. aryl silane diol or aryl silane triol) together with a silane including a hydrolyzable group that forms an acidic species upon hydrolysis (e.g. hydrocarbyl silyl chloride such as trimethyl silyl chloride), the amount of the respective reagents employed may be the same or different. In one or more embodiments, the total amount of stabilizer employed (i.e. both compounds) is, when described as a molar ratio relative to the moles of functionalizing agent, from about 3:1 to about 10:1, in other embodiments from about 4:1 to about 8:1, and in other embodiments from about 5:1 to about 7:1. In these or other embodiments, the molar ratio of the aryl silanol to the silane including a hydrolyzable group that forms an acidic species upon hydrolysis is from about 0.5:1 to about 4:1, in other embodiments from about 1:1 to about 3:1, and in other embodiments from about 1.5:1 to about 2.5:1.

In one or more embodiments, the stabilization of the polymer (i.e., introduction of the stabilizing agent) takes place within the same vessel in which the polymerization took place. In these embodiments, this will include the same vessel in which the modification took place. In other embodiments, stabilization of the polymer (i.e., introduction of the stabilizing agent) takes place outside of the vessel in which the polymerization took place. Likewise, in one or more embodiments, stabilization of the polymer takes place outside of the vessel in which the modification of the polymer took place. For example, in one or more embodiments, the stabilizing agent can be added to the polymerization mixture (i.e., polymer cement) in a vessel or transfer line that is downstream of the vessel in which the polymerization took place and that is downstream of the vessel in which the polymer modification took place. For purposes of this specification, relative to the polymerization vessel, the vessel or conduit in which the stabilizing agent is introduced may be referred to as a second vessel or second reaction zone. In other embodiments, the stabilizing agent may be introduced to the polymer while the polymer is suspended or dissolved within monomer.

### Condensation Accelerator

In one or more embodiments, after the introduction of the functionalizing agent to the reactive polymer, optionally after the addition of a quenching agent and/or antioxidant, optionally after or together with the stabilizing agent, and optionally after recovery or isolation of the functionalized polymer, a condensation accelerator can be added to the polymerization mixture. Useful condensation accelerators include tin and/or titanium carboxylates and tin and/or titanium alkoxides. One specific example is titanium 2-ethylhexyl oxide. Useful condensation catalysts and their use are disclosed in U.S. Publication No. 2005/0159554 (U.S. Pat. No. 7,683,151), which is incorporated herein by reference. In other embodiments, an organic acid can be used as a condensation accelerator. Useful types of organic acids include aliphatic, cycloaliphatic and aromatic monocarboxylic, dicarboxylic, tricarboxylic and tetracarboxylic acids. Specific examples of useful organic acids include, but are not limited to, acetic acid, propionic acid, butyric acid, hexanoic acid, 2-methylhexanoic acid, 2-ethylhexanoic acid, cyclohexanoic acid and benzoic acid.

The amount of condensation accelerator employed in the practice of the present invention can be described with respect to the moles of lithium associated with the initiator. In one or more embodiments, the moles of condensation accelerator per mole of lithium is greater than 1.0, in other embodiments greater than 1.5, and in other embodiments greater than 1.8 moles of condensation accelerator per mole of lithium in the initiator. In these or other embodiments, less than 4.0, in other embodiments less than 3.3, and in other embodiments less than 3.0 moles of condensation accelerator per mole of lithium is introduced to the polymerization mixture. In one or more embodiments, from about 1.0 to about 4.0, in other embodiments from about 1.5 to about 3.3, and in other embodiments from about 1.8 to about 3.0 moles of condensation accelerator per mole of lithium is introduced to the polymerization mixture.

### Antioxidant

In one or more embodiments, after the introduction of the functionalizing agent to the reactive polymer, optionally after the addition of a quenching agent and/or antioxidant, optionally after or together with the stabilizing agent, and optionally after recovery or isolation of the functionalized polymer, an antioxidant can be added to the polymerization mixture. Exemplary antioxidants include 2,6-di-tert-butyl-4-methylphenol.

In one or more embodiments, after formation of the polymer, a processing aid and other optional additives such as oil can be added to the polymer cement.

### Optional Quenching

In one or more embodiments, after the polymerization reaction, or after the reaction between the reactive polymer and the functionalizing agent has been accomplished or completed, a quenching agent can be added to the polymerization mixture in order to inactivate any residual reactive polymer chains and the catalyst or catalyst components. The quenching agent may include a protic compound, which includes, but is not limited to, an alcohol, a carboxylic acid, an inorganic acid, water, or a mixture thereof. The amount of quenching agent employed may be in the range of 0.5 to 10 moles of quenching agent per mole of lithium used to initiate the polymerization.

### Polymer Desolventization

Following polymerization and/or polymer modification, optional stabilization, optional introduction of a condensation accelerator and/or introduction of an antioxidant, the polymer product can be separated from the solvent, which may be referred to as desolventization. In other words, as described above, the polymers are synthesized in an organic solvent, and during the step of desolventization, the organic solvent is separated from the resulting polymer.

In particular embodiments, desolventization includes hot water and/or steam coagulation. For example, the polymerization mixture, which includes the blend of modified polymers, can be combined with a steam or hot water stream. The heat associated with the steam or hot water stream volatilizes the solvent and any unreacted monomer. The polymer product is then dispersed within an aqueous phase in, for example, the form of polymer crumb. The nature and size of the polymer crumb can generally be manipulated by the introduction of mechanical energy (e.g., in the form of mixers).

In one or more embodiments, the polymer crumb is temporarily stored as a crumb dispersion within the water until subsequent drying steps, which are described below. The crumb dispersion is generally a mixture of polymer particles or crumb and water. The polymer particles, which may also be referred to as coagulated polymer, are generally on the macroscale and have at least on dimension that is greater than one mm. This crumb dispersion may be contained within a tank, such as a conventional reactor tank such as a continuously stirred tank reactor.

In one or more embodiments, the polymer crumb can be further processed to remove residual solvent and dry the polymer (i.e., separate the polymer from the water). In practicing the present invention, the polymer can be dried by using conventional techniques, which may include one or more of filtering, pressing, and heating. Following desolventization and drying, the volatile content of the dried polymer can be below 2.0%, in other embodiments below 1.0%, and in other embodiments below 0.5% by weight of the polymer.

In other embodiments, the polymer product can be desolventized by employing devolatilizers, which are extruder-type devices that can operate in conjunction with heat and/or vacuum. In yet other embodiments, the polymerization mixture can be directly drum dried.

Regardless of the methods used to desolventize and dry the polymer, the finished polymer product may be referred to as a dried polymer. Using conventional techniques, the dried polymer can be molded or otherwise manipulated into a bale.

### INDUSTRIAL APPLICABILITY

In one or more embodiments, the polymers of the invention may be used in formulating vulcanizable rubber composition that may, for example, be useful in the preparation of tire components. Rubber compounding techniques and the additives employed therein are generally disclosed in The Compounding and Vulcanization of Rubber, in Rubber Technology (2nd Ed. 1973).

Generally speaking, these vulcanizable rubber compositions include a vulcanizable rubber component, reinforcing filler, and a curative or curative system. These compositions may also optionally include metal activators, resins, and processing oils, as well the various ingredients that may be conventionally included in these vulcanizable rubber compositions.

In one or more embodiments, the polyisoprene polymers of this invention, including the telechelic polyisoprenes, may form all or part of the rubber component of the vulcanizable compositions. That is, the rubber component may include other vulcanizable rubbers, which may also be referred to as elastomeric polymers or simply elastomers.

The rubber compositions can be prepared by using the polyisoprene polymers of this invention alone or together with other elastomers (i.e., polymers that can be vulcanized to form compositions possessing rubbery or elastomeric properties). Other elastomers that may be used include natural and synthetic rubbers. The synthetic rubbers typically derive from the polymerization of conjugated diene monomers, the copolymerization of conjugated diene monomers with other monomers such as vinyl-substituted aromatic monomers, or the copolymerization of ethylene with one or more α-olefins and optionally one or more diene monomers.

Exemplary synthetic rubbers include polybutadiene, polyisobutylene-co-isoprene, neoprene, poly(ethylene-co-propylene), poly(styrene-co-butadiene), poly(styrene-co-isoprene), poly(styrene-co-isoprene-co-butadiene), poly(isoprene-co-butadiene), poly(ethylene-co-propylene-co-diene), polysulfide rubber, acrylic rubber, urethane rubber, silicone rubber, epichlorohydrin rubber, and mixtures thereof. These elastomers can have a myriad of macromolecular structures including linear, branched, and star-shaped structures. Natural rubber is synthesized by and obtained from plant life. For example, natural rubber can be obtained from Hevea rubber trees, guayule shrub, gopher plant, mariola, rabbitbrush, milkweeds, goldenrods, pale Indian plantain, rubber vine, Russian dandelions, mountain mint, American germander, and tall bellflower.

Generally, the rubber compositions of this invention include from about 30 to about 65, in other embodiments from about 35 to about 60, and in other embodiments from about 40 to about 55 weight percent rubber (i.e. the rubber component), based on the total weight of the tire component, of rubber.

In one or more embodiments, the rubber component of the rubber compositions of this invention include from about 1 to about 100 wt %, in other embodiments from about 10 to about 90 wt %, and in other embodiments from about 20 to about 80 wt % of the polyisoprene polymers produced by the techniques of this invention.

As indicated above, the rubber compositions may include fillers such as inorganic and organic fillers. Examples of organic fillers include carbon black and starch. Examples of inorganic fillers include silica, aluminum hydroxide, magnesium hydroxide, mica, talc (hydrated magnesium silicate), and clays (hydrated aluminum silicates). Carbon blacks and silicas are the most common fillers used in manufacturing tires. In certain embodiments, a mixture of different fillers may be advantageously employed.

The amount of total filler employed in the rubber compositions can be up to about 150 parts by weight per 100 parts by weight of rubber (phr), with about 5 to about 125 phr, or about 30 to about 110 phr, being typical. In certain embodiments the total filler content is greater than about 100 phr. In other embodiments, the total filler content is from about 50 to about 100 phr, and in in further embodiments from about 55 to about 95 phr.

In one or more embodiments, carbon blacks include furnace blacks, channel blacks, and lamp blacks. More specific examples of carbon blacks include super abrasion furnace blacks, intermediate super abrasion furnace blacks, high abrasion furnace blacks, fast extrusion furnace blacks, fine furnace blacks, semi-reinforcing furnace blacks, medium processing channel blacks, hard processing channel blacks, conducting channel blacks, and acetylene blacks.

In particular embodiments, the carbon blacks may have a surface area (EMSA) of at least 20 m²/g and in other embodiments at least 35 m²/g; surface area values can be determined by ASTM D-1765 using the cetyltrimethylammonium bromide (CTAB) technique. The carbon blacks may be in a pelletized form or an unpelletized flocculent form. The preferred form of carbon black may depend upon the type of mixing equipment used to mix the rubber compound.

In one or more embodiments, the amount of carbon black employed in the rubber compositions can be up to about 75 parts by weight per 100 parts by weight of rubber (phr), with about 5 to about 6 parts by weight phr, or about 10 to about 55 parts by weight phr, being used in exemplary embodiments.

In one or more embodiments, silicas may be characterized by their surface areas, which give a measure of their reinforcing character. The Brunauer, Emmet and Teller (“BET”) method (described in J. Am. Chem. Soc., 1939, vol. 60, 2 p. 309-319) is a recognized method for determining the surface area. The BET surface area of silica is generally less than 450 m²/g. Useful ranges of surface area include from about 32 to about 400 m²/g, about 100 to about 250 m²/g, and about 150 to about 220 m²/g. In one or more embodiments, the silica may be characterized by a pH of from about 5 to about 7 or slightly over 7, or in other embodiments from about 5.5 to about 6.8. In certain embodiments, the silica employed in the rubber composition is derived from rice husk ash only, and in other embodiments the rubber compositions do not include silica from non-rice husk ash derived processes. Some commercially available silicas which may be used include Hi-Sil™ 215, Hi-Sil™ 233, and Hi-Sil™ 190 (PPG Industries, Inc.; Pittsburgh, Pa.). Other suppliers of commercially available silica include Grace Davison (Baltimore, Md.), Degussa Corp. (Parsippany, N.J.), Rhodia Silica Systems (Cranbury, N.J.), and J. M. Huber Corp. (Edison, N.J.).

In one or more embodiments, the rubber compositions may include from about 1 to about 150, in other embodiments from about 5 to about 140, and in other embodiments from about 10 to about 130 parts by weight silica per 100 parts by weight rubber. In particular embodiments, the present invention includes rubber compositions with high silica loadings, such as loadings greater than 70, in other embodiments greater than 90, and in other embodiments greater than 110 parts by weight silica per 100 parts by weight rubber, with the useful upper end being limited by the high viscosity imparted by silica. When silica is used together with carbon black, the amount of the silica or carbon black can be can be as low as about 1 phr. In one or more embodiments, where carbon black and silica are employed in combination as a filler, the weight ratio or silica to total filler may be from about 5% to about 99% of the total filler, or in other embodiments from about 10% to about 90% of the total filler, or in yet other embodiments from about 50% to about 85% of the total filler.

In one or more embodiments, where silica is employed as a filler (alone or in combination with other fillers), a coupling agent may be added to the rubber compositions during mixing in order to enhance the interaction of silica with the elastomers. Useful coupling agents are disclosed in U.S. Pat. Nos. 3,842,111; 3,873,489; 3,978,103; 3,997,581; 4,002,594; 5,580,919; 5,583,245; 5,663,396; 5,674,932; 5,684,171; 5,684,172; 5,696,197; 6,608,145; 6,667,362; 6,579,949; 6,590,017; 6,525,118; 6,342,552; and 6,683,135; which are incorporated herein by reference.

In one or more embodiments, the amount of coupling agent may be from about 2 to about 30 wt %, in other embodiments from about 4 to about 25 wt %, and in other embodiments from about 6 to about 20 wt % based on the weight of silica within the composition.

In one or more embodiments, where silica is employed as a filler (either alone or in combination with other fillers), a silica dispersing agent, which may include silica shielding agents, may be included in the rubber formulations. The use of one or more silica dispersing agents has been found to be particularly useful in practicing the present invention in view of the multifunctional polymers and/or high silica loadings. In one or more embodiments, useful silica dispersing agents include alkyl alkoxysilanes, fatty acid esters of hydrogenated or non-hydrogenated C5 or C6 sugars, polyoxyethylene derivatives of fatty acid esters of hydrogenated or non-hydrogenated C5 or C6 sugars, and esters of polyols, including glycols and polyhydroxy compounds, and mixtures thereof. In particular embodiments, the silica dispersing agent is glycol monostearate. Useful silane dispersing agents are disclosed in U.S. Pat. Nos. 6,608,145; 7,799,870; 7,897,661; 8,962,746; 9,758,639; 9,951,208; and U.S. Publication Nos. 2004/0152811, and 2005/0070672, which are incorporated herein by reference.

In other embodiments, useful silica dispersing agents include metal glycerolates such as zinc glycerolate, calcium glycerolate, and magnesium glycerolate. These compounds are described in greater detail in U.S. Pat. Nos. 10,087,306 and 11,220,595, and U.S. Publication No. 2021/0388188, which are incorporated herein by reference.

In one or more embodiments, the rubber compositions of the invention may include from about 0.1 to about 30 wt %, in other embodiments from about 1.0 to about 25 wt %, in other embodiments from about 3.0 to about 20 wt %, and in other embodiments from about 4.0 to about 10 wt % silica dispersing agent based on the weight of the silica within the composition. In one or more embodiments, the rubber compositions include greater than 3 wt %, in other embodiments greater than 5 wt %, and in other embodiments greater than 7 wt % dispersing agent based upon the weight of the silica. In these or other embodiments, the rubber compositions may include greater than 3 parts by weight, in other embodiments greater than 4 parts by weight, in other embodiments greater than 5 parts by weight, and in other embodiments greater than 6 parts by weight silica dispersing agent per 100 parts by weight rubber.

A multitude of rubber curing agents (also called vulcanizing agents) may be employed, including sulfur or peroxide-based curing systems. Curing agents are described in Kirk-Othmer, Encyclopedia of Chemical Technology, Vol. 20, pgs. 365-468, (3rd Ed. 1982), particularly Vulcanization Agents and Auxiliary Materials, pgs. 390-402, and A. Y. Coran, Vulcanization, Encyclopedia of Polymer Science and Engineering, (2nd Ed. 1989), which are incorporated herein by reference. Vulcanizing agents may be used alone or in combination.

Other ingredients that are typically employed in rubber compounding may also be added to the rubber compositions. These include accelerators, accelerator activators, oils, plasticizer, waxes, scorch inhibiting agents, processing aids, zinc oxide, tackifying resins, reinforcing resins, fatty acids such as stearic acid, peptizers, and antidegradants such as antioxidants and antiozonants. In particular embodiments, the oils that are employed include those conventionally used as extender oils, which are described above. Generally, the rubber compositions of this invention can include from about 1 to about 70 parts by weight, or in other embodiments from about 5 to about 50 parts weight total oil per 100 parts by weight rubber.

All ingredients of the rubber compositions can be mixed with standard mixing equipment such as, but not limited to, Banbury mixers, Brabender mixers, intermesh mixers including tandem intermesh mixers, extruders, kneaders, and two-roll mills. In one or more embodiments, the ingredients are mixed in two or more stages. In the first stage (often referred to as the masterbatch mixing stage), a so-called masterbatch, which typically includes the rubber component and filler, is prepared. To prevent premature vulcanization (also known as scorch), the masterbatch may exclude vulcanizing agents. The masterbatch may be mixed at a starting temperature of from about 25° C. to about 125° C. with a discharge temperature of about 135° C. to about 180° C. Once the masterbatch is prepared, the vulcanizing agents may be introduced and mixed into the masterbatch in a final mixing stage, which is typically conducted at relatively low temperatures so as to reduce the chances of premature vulcanization. Optionally, additional mixing stages, sometimes called remills, can be employed between the masterbatch mixing stage and the final mixing stage. One or more remill stages are often employed where the rubber composition includes silica as the filler. Various ingredients including the polymers of this invention can be added during these remills.

The mixing procedures and conditions particularly applicable to silica-filled tire formulations are described in U.S. Pat. Nos. 5,227,425; 5,719,207; and 5,717,022, as well as European Patent No. 890,606, all of which are incorporated herein by reference. In one embodiment, the initial masterbatch is prepared by including the polymer and silica in the substantial absence of coupling agents and shielding agents.

The rubber compositions prepared from the polymers of this invention are particularly useful for forming tire components such as treads, subtreads, sidewalls, body ply skims, bead filler, and the like. In one or more embodiments, these tread or sidewall formulations may include from about 10% to about 100% by weight, in other embodiments from about 35% to about 90% by weight, and in other embodiments from about 50% to about 80% by weight of the polymer of this invention based on the total weight of the rubber within the formulation.

Where the rubber compositions are employed in the manufacture of tires, these compositions can be processed into tire components according to ordinary tire manufacturing techniques including standard rubber shaping, molding and curing techniques. Typically, vulcanization is effected by heating the vulcanizable composition in a mold; e.g., it may be heated to about 140° C. to about 180° C. Cured or crosslinked rubber compositions may be referred to as vulcanizates, which generally contain three-dimensional polymeric networks that are thermoset. The other ingredients, such as fillers and processing aids, may be evenly dispersed throughout the crosslinked network. Pneumatic tires can be made as discussed in U.S. Pat. Nos. 5,866,171; 5,876,527; 5,931,211; and 5,971,046, which are incorporated herein by reference.

### EXAMPLES

In order to demonstrate the practice of the present invention, the following examples have been prepared and tested. The examples should not, however, be viewed as limiting the scope of the invention. The claims will serve to define the invention.

### Sample 1

### Synthesis of Di-Li Initiator

To a small N₂ purged sealed glass vessel charged with sec-BuLi (2.84 mL of a 1.49 M solution in hexanes, 4.23 mmol) was added 1,3-diisopropenylbenzene (DIPB) (0.36 mL, 2.1 mmol). To this mixture was added triethylamine (NEt₃) (0.30 mL, 2.1 mmol) resulting in a deep red solution. The mixture was agitated at 50° C. for 2 hours, after which it was used in the polymerization of isoprene.

### Synthesis of Multimodal Polyisoprene

A stainless steel reaction vessel charged with hexanes (3.8 kg) and isoprene (0.64 kg) was treated with 2,2-di(2-tetrahydrofuryl) propane (0.66 mL of a 0.16 M solution in hexanes, 0.11 mmol) followed by the pre-formed Di-Li catalyst described above. The reaction vessel jacket was increased from 25° C. to 50° C. The polymerization reached a peak temperature 66.7° C. after 62 minutes. Analysis of a sample from the reactor 10 minutes after the peak temperature afforded a conversion of 94%. A portion of the contents of the reactor were terminated and coagulated by discharging into a solution of isopropyl alcohol (~8 L) containing 2,5-di-tert-butyl-4-methylphenol (BHT) (~1.8 g/L of isopropyl alcohol).

The polymer obtained from this sample was analyzed for molecular weight moments. Specifically, the number average (Mn), weight average (Mw), and peak (Mp) molecular weights and polydispersity (PDI) were determined by gel permeation chromatography (GPC) using a TOSOH Ecosec HLC-8320 GPC system and TOSOH TSKgel GMHxl-BS columns with THE as a solvent. The system was calibrated using polystyrene (PS) standards and referenced to PS and BR standards.

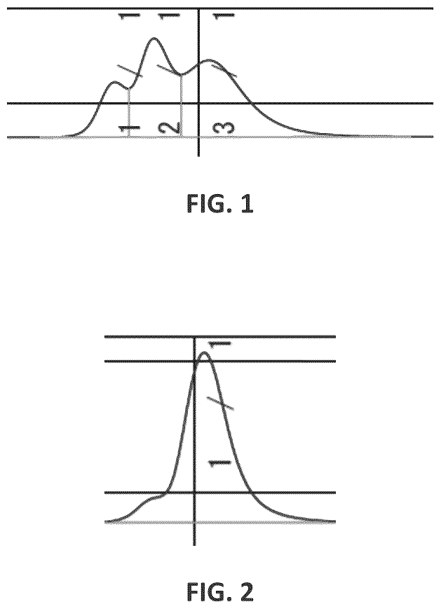

FIG. 1, which as noted above is a GPC trace of the polymer of Sample 1, shows that the polymer is multimodal. Specifically, the polymer had three peaks (Mp1=421 kg/mol, Mp2=988 kg/mol, and Mp3=1.901 kg/mol), with an Mn of 473 kg/mol, an mw of 878 of kg/mol, and a polydispersity of 1.86.

### Sample 2

### Synthesis of Di-Li Initiator

To a small N₂ purged sealed glass vessel charged with sec-BuLi (14.42 mL of a 1.40 M solution in hexanes, 20.2 mmol) was added 1,3-diisopropenylbenzene (DIPB) (1.63 mL, 9.53 mmol). To this mixture was added triethylamine (1.33 mL, 9.53 mmol) resulting in a deep red solution. The mixture was agitated at 50° C. for 2 hours to form a DIPB Di-Li species.

### Synthesis of Di-Li Butadiene Oligomer

To another small N₂ purged sealed glass vessel charged with hexanes (23.0 mL) and a solution of 1,3-butadiene in hexanes (24.1 mL of a 21.2 wt % solution, 63.5 mmol) was added 2,2-di(2-tetrahydrofuryl) propane (1.32 mL of a 0.16 M solution in hexanes, 0.21 mmol) (0.05:1 Li) followed by the above solution of DIPB Di-Li (3.86 mL of a 0.548 M solution, 2.12 mmol). The mixture was agitated at 50° C. for 0.5 hours to form a DIPB-BD Di-Li initiator which was a golden solution with relatively low viscosity.

### Synthesis of Monomodal Polyisoprene

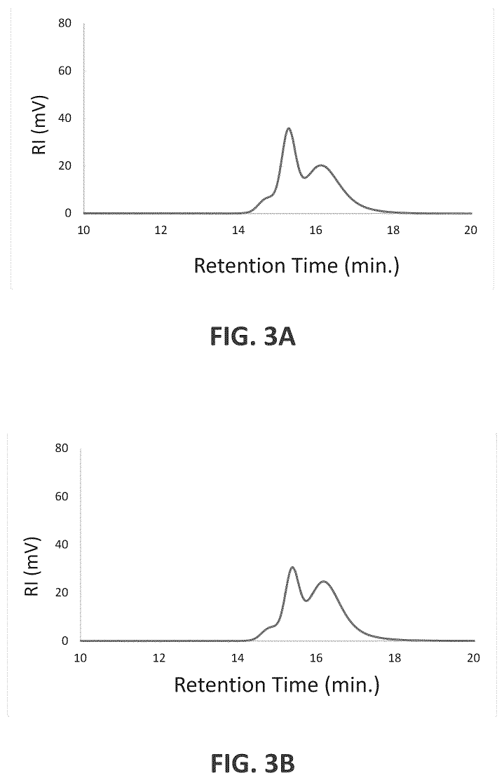

A stainless steel reaction vessel charged with hexanes (3.8 kg) and isoprene (0.64 kg) was treated with the pre-formed DIPB-BD Di-Li initiator described above (51.7 mL of a 0.041 M solution in hexanes, 2.12 mmol). The reaction vessel jacket was increased from 25° C. to 50° C. The polymerization reached a peak temperature 83.2° C. after 38 minutes. Analysis of a sample from the reactor 20 minutes after the peak temperature afforded a conversion of 91%. A portion of the contents of the reactor were terminated and coagulated by discharging into a solution of isopropyl alcohol (~8 L) containing 2,5-di-tert-butyl-4-methylphenol (BHT) (~1.8 g/L of isopropyl alcohol) to afford a non-functionalized control sample that was found to be monomodal (see Table 2 for characterization details and FIG. 2).

The polymer obtained from this sample was analyzed for molecular weight moments using the same techniques as provided in Sample 1. Also, the polymer was analyzed for vinyl content by 400 MHz NMR using CDCl₃ as the solvent.

FIG. 2, which as noted above is a GPC trace of the polymer of Sample 2, shows that the polymer is monomodal. Specifically, the polymer was characterized by an Mn of 387 kg/mol, Mw of 477 kg/mol, Mw/Mn of 1.23, 1,4-cis content of 72.9%, 1,4-trans content of 19.7%, and 3,4-vinyl content of 7.4%.

This sample highlights that by first forming polybutadiene oligomer and then polymerizing isoprene affords a polymer with a relatively narrow monomodal distribution of polymer chains. In addition, this route allows use of a relatively low level of lithium coordinating modifiers to obtain a monomodal distribution which results in a relatively low content of 3,4-vinyl microstructure (<10%).

### Samples 3 to 9

### Synthesis of Di-Li Initiator Stock Solution

To a small N₂ purged sealed glass vessel charged with sec-BuLi (13.74 mL of a 1.40 M solution in hexanes, 19.2 mmol) was added 1,3-disisopropenylbenzene (DIPB) (1.63 mL, 9.53 mmol). To this mixture was added triethylamine NEt₃ (1.33 mL, 9.53 mmol) resulting in a deep red solution. The mixture was agitated at 50° C. for 2 hours, after which a portion of the Di-Li solution (1.75 mL) was diluted with hexanes (8.25 mL) to form a 0.100 M stock solution of the Di-Li initiator.

### Polymerization of Isoprene

A 15 wt % blend of isoprene in hexanes (19.5 mL) was introduced to each of eight 25-mL reactors under a nitrogen atmosphere. After which varying amounts of a 0.016M solution of 2,2-di(2-tetrahydrofuryl) propane (i.e. a Lewis base) was added to each reactor, as shown in Table I, followed by a constant amount of the 0.100 M stock solution of the Di-Li initiator (0.130 mL, 0.0130 mmol). Samples 3-6 were then heated at 50° C. for 3 hours, and Samples 7-10 were heated at 65° C. for 3 hours after which a quench containing 2,5-di-tert-butyl-4-methylphenol (BHT) was added to each reactor. Samples were collected for GPC analysis (see Table I).

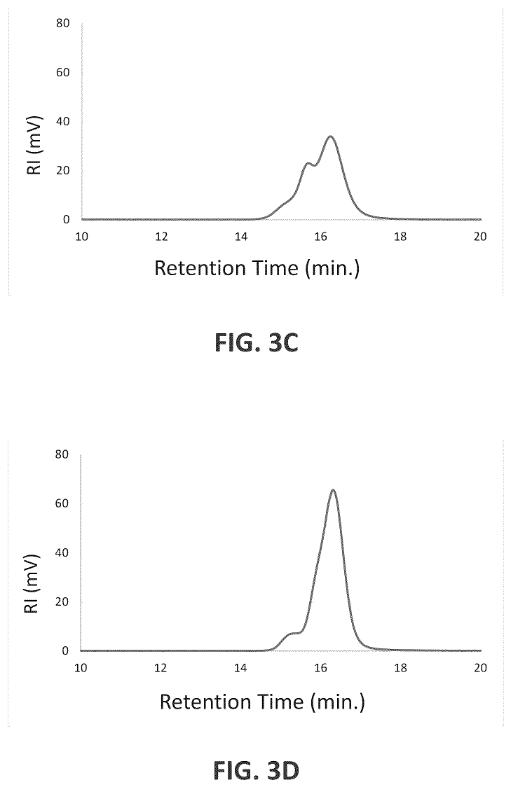

As shown in FIGS. 3A-3D and Table I, use of a Lewis base in sufficient quantity in the polymerization affords a monomodal polymer with typical narrow molecular weight distribution of an anionic polymerization. Increasing the polymerization temperature from 50° C. to 65° C. did not make a significant impact on these results.

TABLE I

| Example | 3 | 4 | 5 | 6 | 7 | 8 | 9 | 10 |
|---|---|---|---|---|---|---|---|---|
| NEt₃/Li | 0.5 | 0.5 | 0.5 | 0.5 | 0.5 | 0.5 | 0.5 | 0.5 |
| OOPS/Li | 0.05 | 0.10 | 0.25 | 0.5 | 0.05 | 0.10 | 0.25 | 0.5 |
| Pzn Temp (° C.) | 50 | 50 | 50 | 50 | 65 | 65 | 65 | 65 |
| Mn (total) | 300461 | 273381 | 271973 | 245685 | 195462 | 193915 | 193715 | 211587 |
| Mw (total) | 453133 | 396239 | 340893 | 283449 | 309736 | 320287 | 264138 | 249724 |
| Mw/Mn | 1.51 | 1.45 | 1.25 | 1.15 | 1.59 | 1.65 | 1.36 | 1.18 |

### Sample 11

### Synthesis of Di-Li Initiator

To a small N₂ purged sealed glass vessel charged with sec-Bull (14.42 ml of a 1.40 M solution in hexanes, 20.2 mmol) was added 1,3-diisopropenylbenzene (DIPB) (1.63 ml, 9.53 mmol). To this mixture was added N,N,N′,N′-tetramethylethylenediamine (TMEDA) (1.43 ml, 9.53 mmol) resulting in a deep red solution. The mixture was agitated at 50° C. for 2 hours, after which a portion of it was used in the polymerization of isoprene.

### Synthesis of Monomodal Polyisoprene

A stainless steel reaction vessel charged with hexanes (3.8 kg) and isoprene (0.64 kg) was treated with 2,2-di(2-tetrahydrofuryl) propane (1.32 ml of a 0.16 M solution in hexanes, 0.21 mmol) (0.10:1 LiDi) followed by a portion of the pre-formed Di-Li catalyst described above (3.88 ml of a 0.545 M solution in hexanes, 2.12 mmol). The reaction vessel jacket was increased from 25° C. to 50° C. The polymerization reached a peak temperature 67.8° C. after 81 minutes. Analysis of a sample from the reactor 20 minutes after the peak temperature afforded a conversion of 90%. A portion of the contents of the reactor were terminated and coagulated by discharging into a solution of isopropyl alcohol (~8 L) containing 2,5-di-tert-butyl-4-methylphenol (BHT) (~1.8 g/L of isopropyl alcohol).

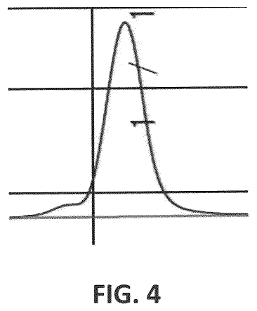

The polymer obtained from this sample was analyzed for molecular weight moments and vinyl content by using the same techniques as provided in Sample 2. FIG. 4, which as noted above is a GPC trace of the polymer of Sample 11, show that the polymer is monomodal. Specifically, the polymer was characterized by an Mn of 312 kg/mol, Mw of 359 kg/mol, Mw/Mn of 1.15, 1,4-cis content of 60.9%, 1,4-trans content of 21.4%, and 3,4-vinyl content of 17.7%.

Various modifications and alterations that do not depart from the scope and spirit of this invention will become apparent to those skilled in the art. This invention is not to be duly limited to the illustrative embodiments set forth herein.

1. A method for polymerizing isoprene, the method comprising:
(i) providing a dilithium initiator;
(ii) introducing the dilithium initiator to isoprene monomer to form a polymerization mixture; and
(iii) allowing the isoprene monomer to polymerize and form polyisoprene, where the polyisoprene is characterized by a monomodal molecular weight distribution.

2. The method of claim 1, where said step of providing a dilithium initiator includes aging the dilithium initiator for greater than 15 minutes in the presence of a Lewis base.

3. (canceled)

4. The method of claim 1, where the dilithium initiator is aged in the presence of an alkylene diamine, and where the molar ratio of the alkylene diamine to lithium atoms associated with the dilithium initiator is greater than 0.05:1.

5. (canceled)

6. The method of claim 1, where the polymerization mixture includes a Lewis base, and where the molar ratio of the Lewis base to the lithium atoms associated with the dilithium initiator is greater than 0.05:1.

7. (canceled)

8. The method of claim 1, further comprising the step of introducing the dilithium initiator to 1,3-butadiene prior to said step of introducing the dilithium initiator to isoprene monomer, and the allowing the 1,3-butadiene to polymerize and form a macromolecule that includes two reactive polybutadiene chains.

9. The method of claim 8, where the amount of 1,3-butadiene to which the dilithium initiator is introduced is represented by a molar ratio of 1,3-butadiene to lithium atoms associated with the dilithium initiator of from about 3:1 to about 100:1.

10. (canceled)

11. (canceled)

12. (canceled)

13. The method of claim 1, further comprising the step of introducing a functionalizing agent to the polymerization mixture to form a telechelic polyisoprene.

14. The method of claim 13, where the functionalizing agent is a hydrocarbyloxy silane defined by the formula: 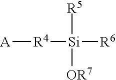
where R⁴ is a divalent organic group, where R⁵ and R⁶ are each independently hydrocarbyloxy groups or hydrocarbyl groups, R⁵ is a monovalent organic group, and A is selected from the group consisting of carboxylic ester, cyclic tertiary amine, non-cyclic tertiary amine, pyridine, silazane, epoxy, isocyanate, cyano, carboxylic anhydride and sulfide groups.

15. The method of claim 13, where after said step of introducing a functionalizing agent to the polymerization mixture to thereby form a telechelic polyisoprene, introducing a stabilizing agent to the polymerization mixture.

16. (canceled)

17. (canceled)

18. (canceled)

19. The method of claim 13, where after said step of introducing a functionalizing agent to the polymerization mixture to thereby form a telechelic polyisoprene, introducing an aryl silanol and a silane including a hydrolyzable group that forms an acidic species upon hydrolysis to the polymerization mixture.

20. (canceled)

21. (canceled)

22. (canceled)

23. The method of claim 1, where the polyisoprene is characterized by a weight average molecular weight of greater than 180 kg/mol and a vinyl content of greater than 10%.

24. (canceled)

25. (canceled)

26. (canceled)

27. (canceled)

28. (canceled)

29. A vulcanizable composition comprising:
(i) the polyisoprene prepared by the method of claim 1;
(ii) silica; and
(iii) a curative.

30. (canceled)

31. (canceled)

32. (canceled)

33. (canceled)

34. (canceled)

35. (canceled)

36. (canceled)

37. (canceled)

38. (canceled)

39. The vulcanizable composition of claim 29, where the polyisoprene is a telechelic polyisoprene formed by reacting the polymer with a functionalizing agent.

40. (canceled)

41. (canceled)

42. A tire tread prepared from the vulcanizable composition of claim 29.

43. (canceled)

44. (canceled)

45. (canceled)

46. (canceled)

47. (canceled)

48. (canceled)

49. (canceled)

50. (canceled)

51. (canceled)
